(19) United States
(12) Patent Application Publication
(10) Pub. No.: US 2024/0195978 A1
(43) Pub. Date: Jun. 13, 2024

(54) JOINT MOTION VECTOR CODING

(71) Applicant: Apple Inc., Cupertino, CA (US)

(72) Inventors: Yeqing WU, Cupertino, CA (US); Yunfei Zheng, Santa Clara, CA (US); Alexandros Tourapis, Los Gatos, CA (US); Yixin Du, Milpitas, CA (US); Alican Nalci, Cupertino, CA (US); Hilmi E. Egilmez, Santa Clara, CA (US); Guoxin Jin, San Diego, CA (US); Jun Xin, San Jose, CA (US); Hsi-Jung Wu, San Jose, CA (US)

(21) Appl. No.: 18/065,220

(22) Filed: Dec. 13, 2022

(51) Int. Cl. H04N 19/137; H04N 19/105; H04N 19/172; H04N 19/176

(52) U.S. Cl. CPC H04N 19/137; H04N 19/105; H04N 19/172; H04N 19/176

(57) ABSTRACT

The present disclosure describes techniques for efficient coding of motion vectors developed for multi-hypothesis coding applications. According to these techniques, when coding hypotheses are developed, each having a motion vector identifying a source of prediction for a current pixel block, a motion vector for a first one of the coding hypotheses may be predicted from the motion vector of a second coding hypothesis. The first motion vector may be represented by coding a motion vector residual, which represents a difference between the developed motion vector for the first coding hypothesis and the predicted motion vector for the first coding hypothesis, and outputting the coded residual to a channel. In another embodiment, a motion vector residual may be generated for a motion vector of a first coding hypothesis, and the first motion vector and the motion vector residual may be used to predict a second motion vector and a predicted motion vector residual. The second hypothesis's motion vector may be coded as a difference between the motion vector, the predicted second motion vector, and the predicted motion vector residual. In a further embodiment, a single motion vector residual may be output for the motion vectors of two coding hypotheses representing a difference between the motion vector of one of the hypotheses and a predicted motion vector for that hypothesis.

### BACKGROUND

Multiple hypothesis inter prediction is widely used in many hybrid video compression standards, such as in the bi-prediction modes in AVC/H.264, HEVC/H.265, and VVC/H.266, and in the inter compound modes in VP3 and AV1. At a high level, the prediction technique creates a final prediction of a pixel block to be coded (called the “current” pixel block, for convenience) by combing multiple predictors. The final prediction usually can achieve better quality (lower distortion) compared to single inter prediction or intra prediction. Variations of this technique include the use of more than two hypotheses to generate the final prediction, the use of illumination compensation parameters, as well as the use of more complex motion models. However, side information (e.g. motion information) needs to be transmitted for each predictor as overhead. Compared to single hypothesis prediction, the additional overhead may reduce the benefits brought by the lower distortion in terms of a joint rate-distortion cost, especially in low bitrate applications. When coding a multiple hypothesis mode, the side information of each predictor typically is coded independently. This may limit the potential of multiple hypothesis inter prediction in video coding.

### BRIEF DESCRIPTION OF THE DRAWINGS

FIG. 1 illustrates a simplified block diagram of a video delivery system according to an aspect of the present disclosure.

FIG. 2 is a functional block diagram illustrating components of an encoding terminal according to an aspect of the present disclosure.

FIG. 3 is a functional block diagram illustrating components of a decoding terminal according to an aspect of the present disclosure.

FIG. 4 illustrates a method of coding motion vector information according to an embodiment of the present disclosure.

FIG. 5 illustrates application of the method of FIG. 4 to an exemplary pair of motion vectors.

FIG. 6 illustrates a method of coding motion vector information according to an embodiment of the present disclosure.

FIG. 7 illustrates application of the method of FIG. 6 to an exemplary pair of motion vectors.

FIG. 8 illustrates a method of coding motion vector information according to an embodiment of the present disclosure.

FIG. 9 illustrates application of the method of FIG. 8 to an exemplary pair of motion vectors.

FIG. 10 is a functional block diagram of a coding system according to an aspect of the present disclosure.

FIG. 11 is a functional block diagram of a decoding system according to an aspect of the present disclosure.

### DETAILED DESCRIPTION

Embodiments of the present disclosure may improve coding of motion vectors developed for multi-hypothesis coding applications. According to these techniques, when inter coding hypotheses are developed, each having a motion vector identifying a source of prediction for a current pixel block, a motion vector for a first one of the coding hypotheses may be predicted from the motion vector of a second coding hypothesis. The first motion vector may be represented by coding a motion vector residual, which represents a difference between the developed motion vector for the first coding hypothesis and the predicted motion vector for the first coding hypothesis, and outputting the coded residual to a channel. In another embodiment, a motion vector residual may be generated for a motion vector of a first coding hypothesis, and the first motion vector and the motion vector residual may be used to predict a second motion vector and a predicted motion vector residual. The second hypothesis's motion vector may be coded as a difference between the motion vector, the predicted second motion vector, and the predicted motion vector residual. In a further embodiment, a single motion vector residual may be output for the motion vectors of two coding hypotheses representing a difference between the motion vector of one of the hypotheses and a predicted motion vector for that hypothesis.

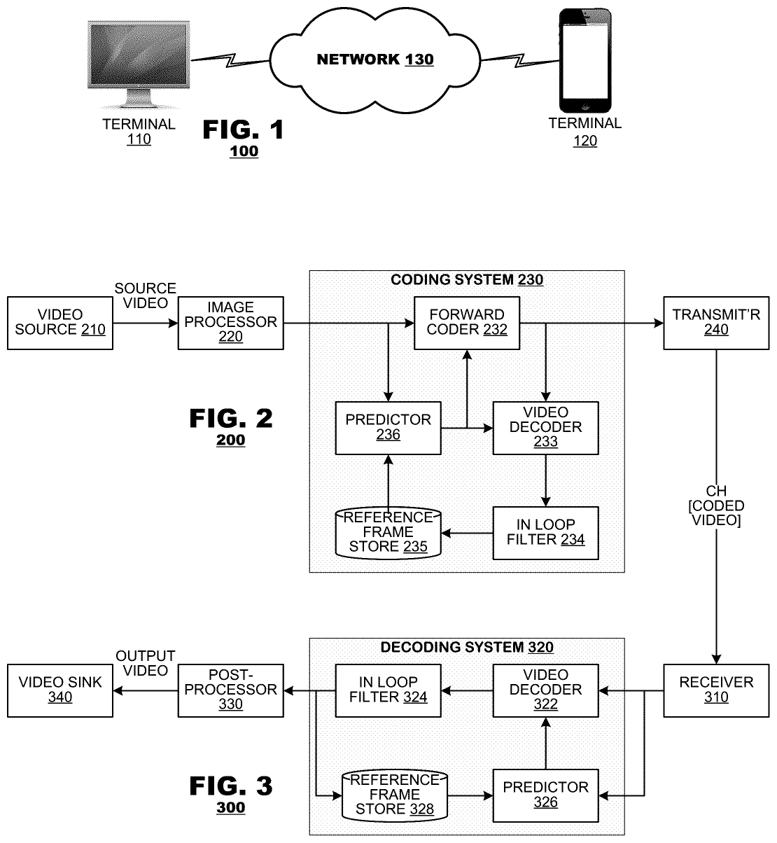

FIG. 1 illustrates a simplified block diagram of a video delivery system 100 according to an aspect of the present disclosure. The system 100 may include a plurality of terminals 110, 120 interconnected via a network 130. The terminals 110, 120 may code video data for transmission to their counterparts via the network 130. Thus, a first terminal 110 may capture video data locally, code the video data, and transmit the coded video data to the counterpart terminal 120 via the network 130. The receiving terminal 120 may receive the coded video data, decode it, and render it locally, for example, on a display at the terminal 120. If the terminals are engaged in bidirectional exchange of video data, then the terminal 120 may capture video data locally, code the video data and transmit the coded video data to the counterpart terminal 110 via the network 130. The receiving terminal 110 may receive the coded video data transmitted from terminal 120, decode it, and render it locally, for example, on its own display. The processes described can operate on both frame and field frame coding but, for simplicity, the present discussion will describe the techniques in the context of integral frames.

A video coding system 100 may be used in a variety of applications. In a first application, the terminals 110, 120 may support real time bidirectional exchange of coded video to establish a video conferencing session between them. In another application, a terminal 110 may code pre-produced video (for example, television or movie programming) and store the coded video for delivery to one or, often, many downloading clients (e.g., terminal 120). Thus, the video being coded may be live or pre-produced, and the terminal 110 may act as a media server, delivering the coded video according to a one-to-one or a one-to-many distribution model. The video content being coded need not be generated by cameras; the principles of the present disclosure apply equally as well to video content generated synthetically, for example, by applications (not shown) executing locally on a terminal 110. For the purposes of the present discussion, the type of video and the video distribution schemes are immaterial unless otherwise noted.

In FIG. 1, the terminals 110, 120 are illustrated as a personal computer and a smart phone, respectively, but the principles of the present disclosure are not so limited. Aspects of the present disclosure also find application with various types of computers (desktop, laptop, and tablet computers), computer servers, media players, game players, dedicated video conferencing equipment and/or dedicated video encoding equipment.

The network 130 represents any number of networks that convey coded video data between the terminals 110, 120, including for example wireline and/or wireless communication networks. The network 130 may exchange data in circuit-switched or packet-switched channels. Representative networks include telecommunications networks, local area networks, wide area networks, and/or the Internet. For the purposes of the present discussion, the architecture and topology of the network 130 are immaterial to the present disclosure unless otherwise noted.

FIG. 2 is a block diagram illustrating functional components of an encoding terminal 200 according to an aspect of the present disclosure. The encoding terminal 200 may include a video source 210, an image processor 220, a coding system 230, and a transmitter 240. The video source 210 may supply video to be coded. The video source 210 may be provided as a camera that captures image data of a local environment, a storage device that stores video from some other source, a locally-executing application, or a network connection through which source video data is received. The image processor 220 may perform signal conditioning operations on the video to be coded to prepare the video data for coding. For example, the preprocessor 220 alter the frame rate, frame resolution, and/or other properties of the source video. The image processor 220 also may perform filtering operations on the source video.

The coding system 230 may perform coding operations on the video to reduce its bandwidth. Typically, the coding system 230 exploits temporal and/or spatial redundancies within the source video. For example, the coding system 230 may perform motion compensated predictive coding in which video frames or field frames are parsed into sub-units (called “pixel blocks,” for convenience), and individual pixel blocks are coded differentially with respect to predicted pixel blocks, which are derived from previously-coded video data. A current pixel block may be coded according to any one of a variety of predictive coding modes, such as:
intra-coding, in which an input pixel block is coded differentially with respect to previously coded/decoded data of a common frame;
single prediction inter-coding, in which an input pixel block is coded differentially with respect to data of a previously coded/decoded frame; and
multi-hypothesis motion compensation predictive coding, in which an input pixel block is coded predictively using decoded data from two or more sources, via temporal or spatial prediction.
   The predictive coding modes may be used cooperatively with other coding techniques, such as Transform Skip coding, RRU coding, scaling of prediction sources, palette coding, and the like.

The coding system 230 may include a forward coder 232, a decoder 233, an in-loop filter 234, a frame buffer 235, and a predictor 236. The coder 232 may apply the differential coding techniques to the current pixel block using predicted pixel block data supplied by the predictor 236. The decoder 233 may invert the differential coding techniques applied by the coder 232 to a subset of coded frames designated as reference frames. The in-loop filter 234 may apply filtering techniques to the reconstructed reference frames generated by the decoder 233. The frame buffer 235 may store the reconstructed reference frames for use in prediction operations. The predictor 236 may predict data for current pixel blocks from within the reference frames stored in the frame buffer.

The coding system 230 may generate coding parameters that identify coding selections performed by the coding system 230. For example, when the coding system 230 selects coding modes for its coding hypotheses, the coding system 230 may provide data to the transmitter 240 that identifies those coding modes. The coding system 230 may select motion vectors, representing spatial displacements between the current pixel block and a block from the reference frame store 235 that is selected as a prediction reference for the current pixel block; data identifying those motion vectors may be provided to the transmitter 240 and transmitted to a decoding terminal (FIG. 3) according to the embodiments discussed hereinbelow.

The transmitter 240 may transmit coded video data to a decoding terminal via a channel CH.

FIG. 3 is a block diagram illustrating functional components of a decoding terminal 300 according to an aspect of the present disclosure. The decoding terminal 300 may include a receiver 310 to receive coded video data from the channel, a video decoding system 320 that decodes coded data, a post-processor 330, and a video sink 340 that consumes the video data.

The receiver 310 may receive a data stream from the network and may route components of the data stream to appropriate units within the terminal 300. Although FIGS. 2 and 3 illustrate functional units for video coding and decoding, terminals 110, 120 (FIG. 1) often will include coding/decoding systems for audio data associated with the video and perhaps other types of data (not shown). Thus, the receiver 310 may parse the coded video data from other elements of the data stream and route it to the video decoder 320.

The video decoding system 320 may perform decoding operations for coded video generated by the coding system 230. The video decoder may include a video decoder 322, an in-loop filter 324, a reference frame store 326, and a predictor 328. The decoder 322 may invert the differential coding techniques applied by the forward coder 232 to the coded frames. The in-loop filter 324 may apply filtering techniques to reconstructed frame data generated by the decoder 322, which replicate operations performed by the in-loop filter 234 (FIG. 2). For example, the in-loop filter 324 may perform various filtering operations (e.g., de-blocking, de-ringing filtering, sample adaptive offset processing, and the like). The filtered frame data may be output from the video decoding system 320. The reference frame store 326 may store reconstructed reference frames for use in prediction operations. The predictor 328 may predict data for input pixel blocks from within the reference frames stored by the frame buffer according to prediction data provided in the coded video data.

The post-processor 330 may perform operations to condition the reconstructed video data for display. For example, the post-processor 330 may perform various filtering operations (e.g., de-blocking, de-ringing filtering, and the like), which may obscure visual artifacts in output video that are generated by the coding/decoding process. The post-processor 330 also may alter resolution, frame rate, color space, etc. of the reconstructed video to conform it to requirements of the video sink 340.

The video sink 340 represents various hardware and/or software components in a decoding terminal that may consume the reconstructed video. The video sink 340 typically may include one or more display devices on which reconstructed video may be rendered. Alternatively, the video sink 340 may be represented by a memory system that stores the reconstructed video for later use. The video sink 340 also may include one or more application programs that process the reconstructed video data according to controls provided in the application program. In some aspects, the video sink may represent a transmission system that transmits the reconstructed video to a display on another device, separate from the decoding terminal; for example, reconstructed video generated by a notebook computer may be transmitted to a large flat panel display for viewing.

The foregoing discussion of the encoding terminal 200 and the decoding terminal 300 (FIGS. 2 and 3) illustrates operations that are performed to code and decode video data in a single direction between terminals, such as from terminal 110 to terminal 120 (FIG. 1). In applications where bidirectional exchange of video is to be performed between the terminals 110, 120, each terminal 110, 120 will possess the functional units associated with an encoding terminal (FIG. 2) and each terminal 110, 120 will possess the functional units associated with a decoding terminal (FIG. 3). Indeed, in certain applications, terminals 110, 120 may exchange multiple streams of coded video in a single direction, in which case, a single terminal (say terminal 110) will have multiple instances of an encoding terminal (FIG. 2) provided therein. Such implementations are fully consistent with the present discussion.

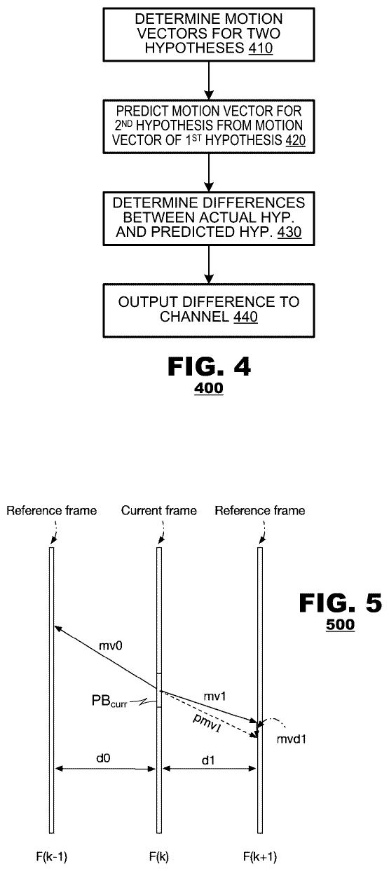

FIG. 4 illustrates a method 400 of coding motion vector information according to an embodiment of the present disclosure. As illustrated, the method 400 may operate on a pair of coding hypothesis each of which generates motion vectors that are to be represented in coded video data. The method 400 may be extended to accommodate any number of coding hypotheses greater than two simply by repeating the method 400 on other pairs of coding hypotheses.

The method 400 may begin when motion vectors are determined for two coding hypotheses (box 410). The method 400 may predict a motion vector for one of the hypothesis (labeled the “second” hypothesis in FIG. 4) using the other motion vector (from “first” hypothesis) as a prediction reference (box 420). The method 400 may determine a difference between the actual motion vector of the second hypothesis and the predicted motion vector of the second hypothesis (box 430) and output data representing this difference to a channel (box 440).

FIG. 5 illustrates application of the method 400 of FIG. 4 to an exemplary pair of motion vectors mv0 and mv1. In the example of FIG. 5, motion vectors mv0 and mv1 represent motion vectors developed for a current pixel block PB_{curr} according to two coding hypotheses. Motion vector mv0 identifies a location of a prediction pixel block for the current pixel block PB_{curr} taken from a first reference frame F(k−1) and motion vector mv1 identifies a location of a prediction pixel block for the current pixel block PB_{curr} taken from a second reference frame F(k+1). In this example, a prediction of the motion vector mv1, shown as pmv1, is developed from motion vector mv0 via operation of box 420 (FIG. 4). The predicted motion vector pmv1 is spatially offset from the actual motion vector mv1 by an amount shown as mvd1. The method 400 (FIG. 4) determines the value of this difference mvd1 (box 430) and outputs data representing the difference to a channel (box 440).

It is expected that a video coder 230 (FIG. 2) that operates the method 400 (FIG. 4) also will output data representing the motion vector mv0 of the first coding hypothesis. Thus, motion vectors for the two coding hypotheses may be output as a representation of mv0 and a representation of mvd1. It is unnecessary to output data representing the motion vector mv1. Typically, coding of mvd1 will incur fewer bits than coding of mv1 and, therefore, the method 400 is expected to lead to higher coding efficiencies than other systems that would encode mv1 directly.

The motion vector syntax elements mv0 and mvd1 may be used by a coding system 230 (FIG. 2) and a decoding system 320 (FIG. 3) for use in pixel block prediction processes. For example, the mv0 motion vector may be applied to retrieve a pixel block from reference frame F(k−1) as a prediction reference for the current pixel block PB_{curr} for use in the first hypothesis. The mvd1 syntax element may be used to recover a motion vector mv1 by combining the mvd1 with a predicted value recovered from mv0 syntax element (e.g., mv1=pmv1+mvd1). The recovered mv1 motion vector may be applied to retrieve a pixel block from reference frame F(k+1) as a prediction reference for the current pixel block PB_{curr} for use in the second hypothesis.

Motion vector prediction may occur in a variety of ways, for example, by scaling, mapping, or transforming the reference motion vector from which it is derived. Typically, motion vector prediction will consider the magnitude of the reference motion vector (mv0 in FIG. 5) and the temporal distances d0, d1 between a frame F(k) of the current pixel block and the reference frames F(k−1) and F(k+1) to develop a prediction for another motion vector. For example, the predicted motion vector pmv1 may be derived as:

$$pmv 1 = - mv 0 * \frac{d 1}{d 0} .$$

In a simple mapping, the predictor pmv1 may be taken as the inverse of mv0 (e.g., pmv1=−mv0). Of course, more complex mathematical transforms may be used.

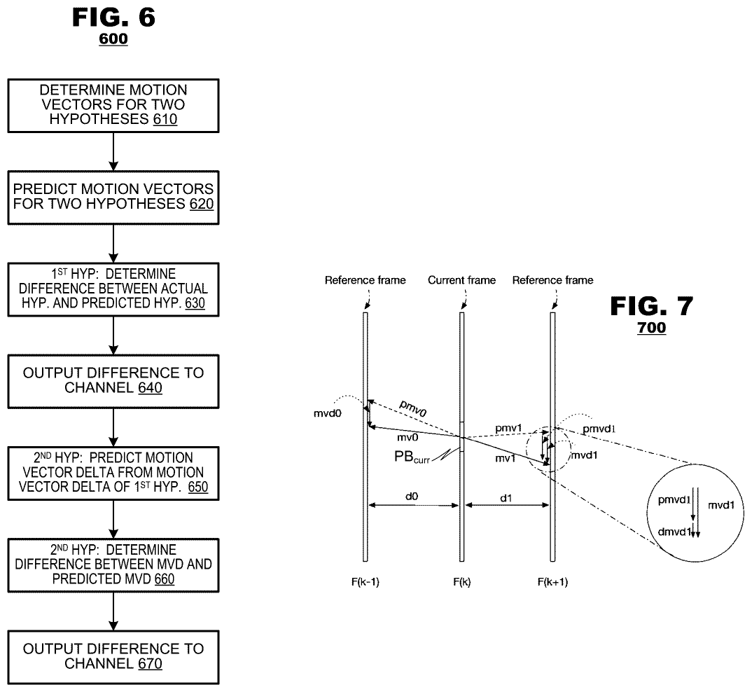

FIG. 6 illustrates a method 600 of coding motion vector information according to another embodiment of the present disclosure. Here, again, the method 600 is shown as operating on a pair of coding hypothesis each of which generates motion vectors that are to be represented in coded video data. The method 600 may be extended to accommodate any number of coding hypotheses greater than two simply by repeating the method 600 on other pairs of coding hypotheses.

The method 600 may begin when motion vectors are determined for two coding hypotheses (box 610). The method 600 may predict motion vectors for the two hypotheses using the previously-coded motion vectors as prediction references (box 620). The method 600 may determine, for one of the coding hypotheses (labeled the “first” hypothesis in FIG. 6) a difference between the actual motion vector of the first hypothesis and the predicted motion vector of the first hypothesis (box 630) and output data representing this difference to a channel (box 640). The method 600 may predict, for the second of the coding hypotheses, a motion vector difference from the motion vector difference of the first motion vector (box 650). The method 600, thereafter, may determine a difference between the predicted motion vector difference and the actual motion vector difference determined between the predictive motion vector and the actual motion vector (box 660). The method 600 may output data representing the predicted motion difference to a channel (box 670).

FIG. 7 illustrates application of the method 600 of FIG. 6 to an exemplary pair of motion vectors mv0 and mv1. In the example of FIG. 7, motion vectors mv0 and mv1 represent motion vectors developed for a current pixel block PB_{curr} according to two coding hypotheses. Motion vector mv0 identifies a location of a prediction pixel block for the current pixel block PB curr taken from a first reference frame F(k−1) and motion vector mv1 identifies a location of a prediction pixel block for the current pixel block PB_{curr} taken from a second reference frame F(k+1).

FIG. 7 illustrates, for the first coding hypothesis, a predicted motion vector pmv0. The difference between these motion vectors developed in box 630 is shown as mvd0. This difference may be represented in coding data that is output to a channel in box 640.

FIG. 7 illustrates a predicted motion vector pmv1 for the second coding hypothesis. FIG. 7 also illustrates a predicted motion vector difference mvd1, which is developed as a difference between the motion vector mv1 for the second hypothesis and its predicted valued pmv1. A difference dmvd1 between the motion vector difference mvd1 for the second hypothesis and the predicted motion vector difference pmvd1 may be output in box 670 as data representing the motion vector of the second hypothesis.

The predicted motion vectors pmv0, pmv1 may be developed in a variety of ways. In one embodiment, a motion vector of a pixel block from a most recently coded frame (not shown) at a pixel block location co-located with the current pixel block PB_{curr} may be taken as the predicted motion vector. In another embodiment, a motion vector of a pixel block from a most recently coded reference frame (also not shown) at a pixel block location co-located with the current pixel block PB_{curr} may be taken as the predicted motion vector.

The predicted motion vector difference pmvd1 may consider the magnitude of the motion vector prediction difference (mvd0 in FIG. 7) and the temporal distances d0, d1, for example, as:

$$pmvd 1 = mvd 0 * \frac{d 1}{d 0} .$$

Application of the method 600 of FIG. 6 may cause two syntax elements of coded motion vectors, mvd0 and dmvd1, to be output from a coder to represent the two motion vectors illustrated in FIG. 7. These data elements are expected to have smaller magnitudes than data elements that represent motion vectors mv0 and mv1 and, by extension, to incur fewer bits to encode these syntax elements. Thus, it is expected that the method 600 of FIG. 6 will lead to higher coding efficiencies than other systems that would encode mv0 and mv1 directly.

The motion vector syntax elements mvd0 and dmvd1 may be used by a coding system 230 (FIG. 2) and a decoding system 320 (FIG. 3) for use in pixel block prediction processes. For example, the mvd0 motion vector may be applied to a predicted motion vector pmv0 to recover a motion vector mv0 (e.g., mv0=pmv0+mvd0). The motion vector mv0 may be applied to retrieve a pixel block from reference frame F(k−1) as a prediction reference for the current pixel block PB_{curr} for use in the first hypothesis.

The dmvd1 syntax element may be used to recover a motion vector mv1 by combining it with the predicted motion vector pmvd1 and the predicted motion vector difference mvd1, with a predicted value recovered from mv0 syntax element (e.g., mv1=pmv1+pmvd1+dmvd1). The recovered mv1 motion vector may be applied to retrieve a pixel block from reference frame F(k+1) as a prediction reference for the current pixel block PB_{curr} for use in the second hypothesis.

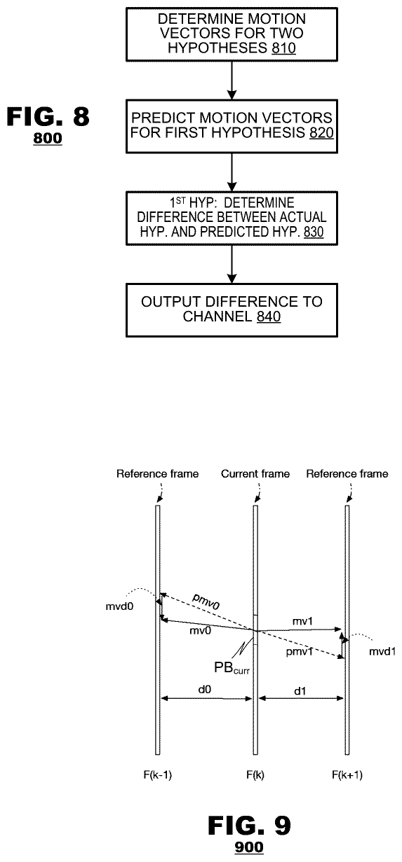

FIG. 8 illustrates a method 800 of coding motion vector information according to a further embodiment of the present disclosure. As illustrated, the method 800 operates on a pair of coding hypothesis each of which generates motion vectors that are to be represented in coded video data. The method 800 may be extended to accommodate any number of coding hypotheses greater than two simply by repeating the method 800 on other pairs of coding hypotheses.

The method 800 may begin when motion vectors are determined for two coding hypotheses (box 810). The method 800 may predict motion vector for one of the hypotheses (box 820) and may determine a difference between the determined motion vector and the predicted motion vector (box 830). The method 800 may output data representing the determined difference to a channel (box 840). In the embodiment of FIG. 8, the difference value that is output to the channel may be employed as a motion vector prediction residual for the first and second hypotheses.

The predicted motion vector pmv0 may be developed in a variety of ways. In one embodiment, a motion vector of a pixel block from a most recently coded frame (not shown) at a pixel block location co-located with the current pixel block PB_{curr} may be taken as the predicted motion vector pmv0. In another embodiment, a motion vector of a pixel block from a most recently coded reference frame (also not shown) at a pixel block location co-located with the current pixel block PB_{curr} may be taken as the predicted motion vector pmv0.

FIG. 9 illustrates application of the method 800 of FIG. 8 to an exemplary pair of motion vectors mv0 and mv1. In the example of FIG. 9, motion vectors mv0 and mv1 represent motion vectors developed for a current pixel block PB_{curr} according to two coding hypotheses. Motion vector mv0 identifies a location of a prediction pixel block for the current pixel block PB curr taken from a first reference frame F(k−1) and motion vector mv1 identifies a location of a prediction pixel block for the current pixel block PB_{curr} taken from a second reference frame F(k+1).

FIG. 9 illustrates, for the first coding hypothesis, a predicted motion vector pmv0. The difference between these motion vectors developed in box 830 is shown as mvd0. This difference may be represented in coding data that is output to a channel in box 840.

The motion vector difference syntax element mvd0 may be used by a coding system 230 (FIG. 2) and a decoding system 320 (FIG. 3) for use in pixel block prediction processes. For example, the motion vector difference mvd0 may be applied to a predicted motion vector pmv0 to recover a motion vector mv0 (e.g., mv0=pmv0+mvd0). The motion vector mv0 may be applied to retrieve a pixel block from reference frame F(k−1) as a prediction reference for the current pixel block PB_{curr} for use in the first hypothesis. The same motion vector difference mvd0 may be applied to a predicted motion vector pmv1 to recover a motion vector mv1 (e.g., mv1=pmv1+mvd0). The recovered motion vector mv1 may be applied to retrieve a pixel block from reference frame F(k+1) as a prediction reference for the current pixel block PB_{curr} for use in the first hypothesis.

In other cases, the motion vector difference mvd1 may be derived from the motion vector difference mvd0 syntax element by a scaling, mapping, or transform process. For example, mvd1 may be derived as

$$mvd 1 = mmd 0 * \frac{d 1}{d 0} ,$$

where the d0 and d1 represent temporal distances of the frames F(k−1) and F(k+1) to the frame F(k) being coded.

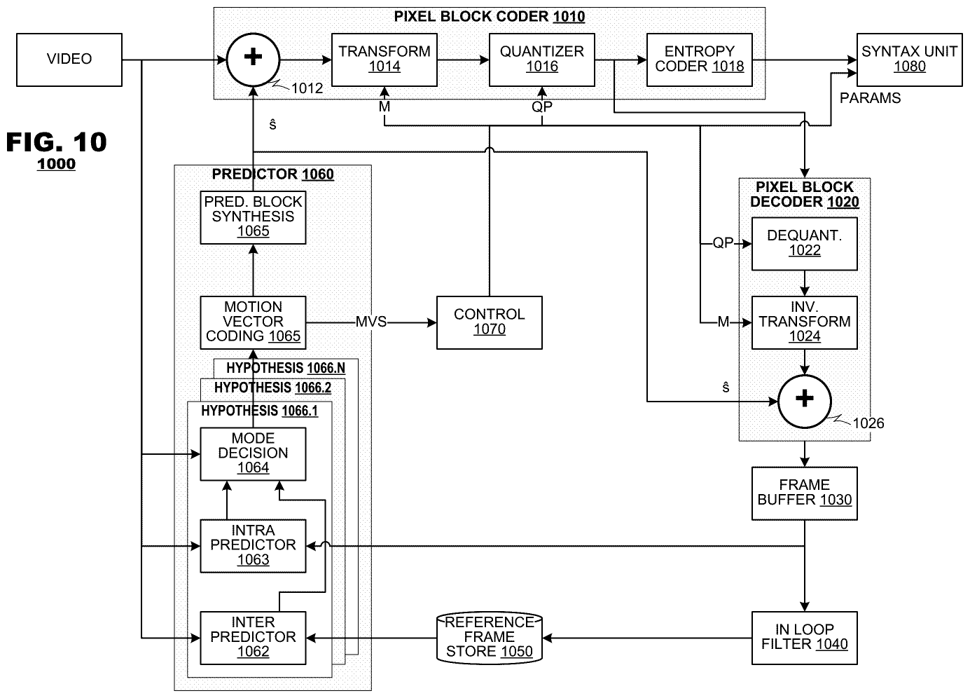

FIG. 10 is a functional block diagram of a coding system 1000 according to an aspect of the present disclosure. The coding system 1000 may find application as a coding terminal as shown in FIGS. 1 and/or 2. The system 1000 may include a pixel block coder 1010, a pixel block decoder 1020, a frame buffer 1030, an in-loop filter system 1040, a reference frame store 1050, a predictor 1060, a controller 1070, and a syntax unit 1080. The predictor 1060 may develop the different coding hypotheses for use during coding of a newly-presented input pixel block s and it may supply a prediction block s to the pixel block coder 1010. The pixel block coder 1010 may code the new pixel block by predictive coding techniques and present coded pixel block data to the syntax unit 1080. The pixel block decoder 1020 may decode the coded pixel block data, generating decoded pixel block data therefrom. The frame buffer 1030 may generate reconstructed frame data from the decoded pixel block data. The in-loop filter 1040 may perform one or more filtering operations on the reconstructed frame. For example, the in-loop filter 1040 may perform deblocking filtering, sample adaptive offset (SAO) filtering, adaptive loop filtering (ALF), maximum likelihood (ML) based filtering schemes, deringing, debanding, sharpening, resolution scaling, and the like. The reference frame store 1050 may store the filtered frame, where it may be used as a source of prediction of later-received pixel blocks. The syntax unit 1080 may assemble a data stream from the coded pixel block data, which conforms to a governing coding protocol.

In multi-hypothesis coding, the predictor 1060 may select the different hypotheses from among the different candidate prediction modes that are available under a governing coding syntax. The predictor 1060 may decide, for example, the number of hypotheses that may be used, the prediction sources for those hypotheses and, in certain aspects, partitioning sizes at which the predictions will be performed. For example, the predictor 1060 may decide whether a given input pixel block will be coded using a prediction block that matches the sizes of the input pixel block or whether it will be coded using prediction blocks at smaller sizes. The predictor 1060 also may decide, for some smaller-size partitions of the input block, that SKIP coding will be applied to one or more of the partitions (called “null” coding herein).

As part of the multi-hypothesis coding, the predictor 1060 may predict motion vectors for transmission to a decoding terminal 120 (FIG. 1) or 300 (FIG. 3) according to the techniques described hereinabove with respect to FIGS. 4-9. The predictor 1060 may output motion vector parameters (shown in FIG. 10 as mvs) to the controller 1070, which may provide those parameters to the syntax unit 1080 for formatting according to a governing coding syntax.

In an embodiment, a coding system 1000 may alternate between performance of the method 400 of FIG. 4, the method 600 of FIG. 6, and the method 800 of FIG. 8 for different pixel blocks as they are coded. The controller 1070 may identify in appropriate syntax elements of a coding protocol, which method 400, 600, or 800 is applicable to a given pixel block. For example, the controller 1070 may make such identifications at a frame level, a slice level, or a coding unit level of the coding protocol.

The pixel block coder 1010 may include a subtractor 1012, a transform unit 1014, a quantizer 1016, and an entropy coder 1018. The pixel block coder 1010 may accept pixel blocks of input data at the subtractor 1012. The subtractor 1012 may receive predicted pixel blocks s from the predictor 1060 and generate an array of pixel residuals therefrom representing a difference between the input pixel block and the predicted pixel block. The transform unit 1014 may apply a transform to the sample data output from the subtractor 1012, to convert data from the pixel domain to a domain of transform coefficients. The quantizer 1016 may perform quantization of transform coefficients output by the transform unit 1014. The quantizer 1016 may be a uniform or a non-uniform quantizer. The entropy coder 1018 may reduce bandwidth of the output of the coefficient quantizer by coding the output, for example, by variable length code words or using a context adaptive binary arithmetic coder.

The transform unit 1014 may operate in a variety of transform modes M as determined by the controller 1070. For example, the transform unit 1014 may apply a discrete cosine transform (DCT), a discrete sine transform (DST), a Walsh-Hadamard transform, a Haar transform, a Daubechies wavelet transform, or the like. In an aspect, the controller 1070 may select a coding mode M to be applied by the transform unit 1015, may configure the transform unit 1015 accordingly and may signal the coding mode M in the coded video data, either expressly or impliedly.

The quantizer 1016 may operate according to a quantization parameter QP that is supplied by the controller 1070. In an aspect, the quantization parameter QP may be applied to the transform coefficients as a multi-value quantization parameter, which may vary, for example, across different coefficient locations within a transform-domain pixel block. Thus, the quantization parameter QP may be provided as a quantization parameters array.

The entropy coder 1018, as its name implies, may perform entropy coding of data output from the quantizer 1016. For example, the entropy coder 1018 may perform run length coding, Huffman coding. Golomb coding. Context Adaptive Binary Arithmetic Coding, and the like.

The pixel block decoder 1020 may invert coding operations of the pixel block coder 1010. For example, the pixel block decoder 1020 may include a dequantizer 1022, an inverse transform unit 1024, and an adder 1026. The pixel block decoder 1020 may take its input data from an output of the quantizer 1016. Although permissible, the pixel block decoder 1020 need not perform entropy decoding of entropy-coded data since entropy coding is a lossless event. The dequantizer 1022 may invert operations of the quantizer 1016 of the pixel block coder 1010. The dequantizer 1022 may perform uniform or non-uniform de-quantization as specified by the decoded signal QP. Similarly, the inverse transform unit 1024 may invert operations of the transform unit 1014. The dequantizer 1022 and the inverse transform unit 1024 may use the same quantization parameters QP and transform mode M as their counterparts in the pixel block coder 1010. Quantization operations likely will truncate data in various respects and, therefore, data recovered by the dequantizer 1022 likely will possess coding errors when compared to the data presented to the quantizer 1016 in the pixel block coder 1010.

The adder 1026 may invert operations performed by the subtractor 1012. It may receive the same prediction pixel block s from the predictor 1060 that the subtractor 1012 used in generating residual signals. The adder 1026 may add the prediction pixel block to reconstructed residual values output by the inverse transform unit 1024 and may output reconstructed pixel block data.

As described, the frame buffer 1030 may assemble a reconstructed frame from the output of the pixel block decoders 1020. The in-loop filter 1040 may perform various filtering operations on recovered pixel block data. For example, the in-loop filter 1040 may include a deblocking filter, a sample adaptive offset (“SAO”) filter, and/or other types of in loop filters (not shown).

The reference frame store 1050 may store filtered frame data for use in later prediction of other pixel blocks. Different types of prediction data are made available to the predictor 1060 for different prediction modes. For example, for an input pixel block, intra prediction takes a prediction reference from decoded data of the same frame (usually, unfiltered) in which the input pixel block is located. For the same input pixel block, inter prediction may take a prediction reference from previously coded and decoded frame(s) that are designated as reference frames. Thus, the reference frame store 1050 may store these decoded reference frames.

As discussed, the predictor 1060 may supply prediction blocks ŝ to the pixel block coder 1010 for use in generating residuals. The predictor 1060 may include, for each of a plurality of hypotheses 1061.1-1061.n, an inter predictor 1062, an intra predictor 1063, and a mode decision unit 1062. The different hypotheses 1061.1-1061.n may operate at different partition sizes as described above. For each hypothesis, the inter predictor 1062 may receive pixel block data representing a new pixel block to be coded and may search reference frame data from store 1050 for pixel block data from reference frame(s) for use in coding the input pixel block. The inter-predictor 1062 may perform its searches at the partition sizes of the respective hypothesis. Thus, when searching at smaller partition sizes, the inter-predictor 1062 may perform multiple searches, one using each of the sub-partitions at work for its respective hypothesis. The inter predictor 1062 may select prediction reference data that provides a closest match to the input pixel block being coded. The inter predictor 1062 may generate prediction reference metadata, such as prediction block size and motion vectors, to identify which portion(s) of which reference frames were selected as source(s) of prediction for the input pixel block.

The intra predictor 1063 may support Intra (I) mode coding. The intra predictor 1063 may search from among pixel block data from the same frame as the pixel block being coded that provides a closest match to the input pixel block. The intra predictor 1063 also may run searches at the partition size for its respective hypothesis and, when sub-partitions are employed, separate searches may be run for each sub-partition. The intra predictor 1063 also may generate prediction mode indicators to identify which portion of the frame was selected as a source of prediction for the input pixel block.

The mode decision unit 1064 may select a final coding mode for the hypothesis from the output of the inter-predictor 1062 and the inter-predictor 1063. The mode decision unit 1064 may output prediction data and the coding parameters (e.g., selection of reference frames, motion vectors and the like) for the mode selected for the respective hypothesis. Typically, as described above, the mode decision unit 1064 will select a mode that achieves the lowest distortion when video is decoded given a target bitrate. Exceptions may arise when coding modes are selected to satisfy other policies to which the coding system 1000 adheres, such as satisfying a particular channel behavior, or supporting random access or data refresh policies.

The predictor 1060 may include a motion vector coding unit 1065 that operates according to the methods described hereinabove with respect to FIGS. 4, 6, and/or 8. When motion vectors are presented by two or more hypothesis coding units 1066.1, 1066.2, . . . , 1066.n, the motion vector coding unit 1060 may code the motion vectors according to the techniques of these methods. The motion vector coding unit 1065 may output motion vector syntax elements to the controller 1070 as determined by the respective methods 400 (FIG. 4), 600 (FIG. 6), or 800 (FIG. 8).

Prediction data output from the mode decision units 1064 of the different hypotheses 1061.1-1061.N may be input to a prediction block synthesis unit 1065, which merges the prediction data into an aggregate prediction block s. In an embodiment, the prediction block s may be formed from a combination of the predictions from the individual hypotheses. The prediction block synthesis unit 1065 may supply the prediction block s to the pixel block coder 1010. The predictor 1060 may output to the controller 1070 parameters representing coding decisions for each hypothesis.

The controller 1070 may control overall operation of the coding system 1000. The controller 1070 may select operational parameters for the pixel block coder 1010 and the predictor 1060 based on analyses of input pixel blocks and also external constraints, such as coding bitrate targets and other operational parameters. As is relevant to the present discussion, when it selects quantization parameters QP, the use of uniform or non-uniform quantizers, and/or the transform mode M, it may provide those parameters to the syntax unit 1080, which may include data representing those parameters in the data stream of coded video data output by the system 1000. The controller 1070 also may select between different modes of operation by which the system may generate reference images and may include metadata identifying the modes selected for each portion of coded data.

During operation, the controller 1070 may revise operational parameters of the quantizer 1016 and the transform unit 1015 at different granularities of image data, either on a per pixel block basis or on a larger granularity (for example, per frame, per slice, per largest coding unit (“LCU”) or Coding Tree Unit (CTU), or another region). In an aspect, the quantization parameters may be revised on a per-pixel basis within a coded frame.

Additionally, as discussed, the controller 1070 may control operation of the in-loop filter 1040 and the prediction unit 1060. Such control may include, for the prediction unit 1060, mode selection (lambda, modes to be tested, search windows, distortion strategies, etc.), and, for the in-loop filter 1040, selection of filter parameters, reordering parameters, weighted prediction, etc.

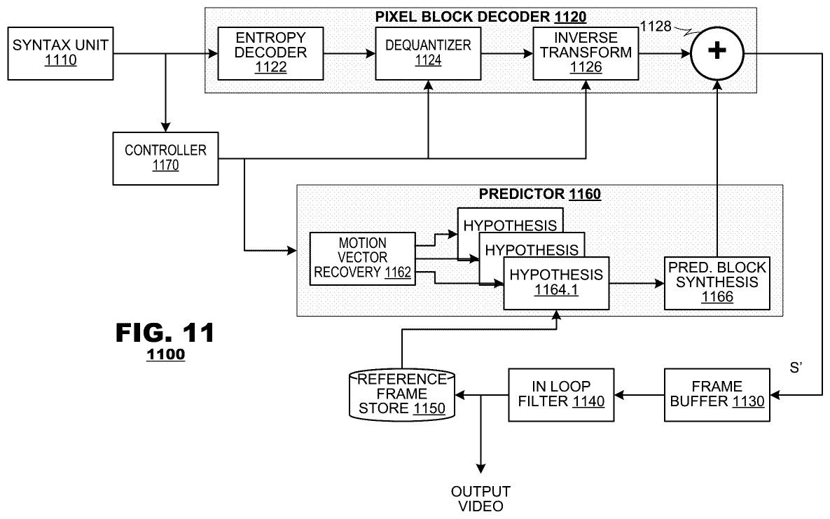

FIG. 11 is a functional block diagram of a decoding system 1100 according to an aspect of the present disclosure. The decoding system 1100 may include a syntax unit 1110, a pixel block decoder 1120, a frame buffer 1130, an in-loop filter 1140, a reference frame store 1150, a predictor 1160, and a controller 1170.

The syntax unit 1110 may receive a coded video data stream and may parse the coded data into its constituent parts. Data representing coding parameters may be furnished to the controller 1170, while data representing coded residuals (the data output by the pixel block coder 1010 of FIG. 10) may be furnished to its respective pixel block decoder 1120. The predictor 1160 may generate a prediction block s from reference data available in the reference frame store 1150 according to coding parameter data provided in the coded video data. It may supply the prediction block s to the pixel block decoder. The pixel block decoder 1120 may invert coding operations applied by the pixel block coder 1010 (FIG. 10). The frame buffer 1130 may create a reconstructed frame from decoded pixel blocks s′ output by the pixel block decoder 1120. The in-loop filter 1140 may filter the reconstructed frame data. The filtered frames may be output from the decoding system 1100. Filtered frames that are designated to serve as reference frames also may be stored in the reference frame store 1150.

The pixel block decoder 1120 may include an entropy decoder 1122, a dequantizer 1124, an inverse transform unit 1126, and an adder 1128. The entropy decoder 1122 may perform entropy decoding to invert processes performed by the entropy coder 1018 (FIG. 10). The dequantizer 1124 may invert operations of the quantizer 1116 of the pixel block coder 1010 (FIG. 10). Similarly, the inverse transform unit 1126 may invert operations of the transform unit 1014 (FIG. 10). They may use the quantization parameters QP and transform modes M that are provided in the coded video data stream. Because quantization is likely to truncate data, the pixel blocks s′ recovered by the dequantizer 1124, likely will possess coding errors when compared to the input pixel blocks s presented to the pixel block coder 1010 of the encoder (FIG. 10).

The adder 1128 may invert operations performed by the subtractor 1010 (FIG. 10). It may receive a prediction pixel block from the predictor 1160 as determined by prediction references in the coded video data stream. The adder 1128 may add the prediction pixel block to reconstructed residual values output by the inverse transform unit 1126 and may output reconstructed pixel block data.

As described, the frame buffer 1130 may assemble a reconstructed frame from the output of the pixel block decoder 1120. The in-loop filter 1140 may perform various filtering operations on recovered pixel block data as identified by the coded video data. For example, the in-loop filter 1140 may include a deblocking filter, a sample adaptive offset (“SAO”) filter, and/or other types of in loop filters. In this manner, operation of the frame buffer 1130 and the in loop filter 1140 mimics operation of the counterpart frame buffer 1030 and in loop filter 1040 of the encoder 1000 (FIG. 10).

The reference frame store 1150 may store filtered frame data for use in later prediction of other pixel blocks. The reference frame store 1150 may store decoded frames as it is coded for use in intra prediction. The reference frame store 1150 also may store decoded reference frames.

As discussed, the predictor 1160 may supply the prediction blocks ŝ to the pixel block decoder 1120. The predictor 1160 may have a motion vector recovery unit 1162 that recovers motion vectors for the respective hypotheses 1162.1-1162.n according to the techniques described herein with respect to FIGS. 4, 6, and/or 8. The predictor 1160 may retrieve prediction data from the reference frame store 1150 for each of the hypotheses represented in the coded video data (represented by hypothesis predictors 1164.1-1164.n). A prediction block synthesis unit 1164 may generate an aggregate prediction block s from the prediction data of the different hypothesis. In this manner, the prediction block synthesis unit 1166 may replicate operations of the synthesis unit 1065 from the encoder (FIG. 10). The predictor 1160 may supply predicted pixel block data as determined by the prediction reference indicators supplied in the coded video data stream.

The controller 1170 may control overall operation of the coding system 1100. The controller 1170 may set operational parameters for the pixel block decoder 1120 and the predictor 1160 based on parameters received in the coded video data stream. As is relevant to the present discussion, these operational parameters may include quantization parameters QP for the dequantizer 1124, transform modes M for the inverse transform unit 1110, and identifications of the methods 400, 600, or 800 by which motion vectors are represented. As discussed, the received parameters may be set at various granularities of image data, for example, on a per pixel block basis, a per frame basis, a per slice basis, a per LCU/CTU basis, or based on other types of regions defined for the input image.

The foregoing discussion has described operation of the aspects of the present disclosure in the context of video coders and decoders. Commonly, these components are provided as electronic devices. Video decoders and/or controllers can be embodied in integrated circuits, such as application specific integrated circuits, field programmable gate arrays, and/or digital signal processors. Alternatively, they can be embodied in computer programs that execute on camera devices, personal computers, notebook computers, tablet computers, smartphones, or computer servers. Such computer programs typically are stored in physical storage media such as electronic-, magnetic-, and/or optically-based storage devices, where they are read to a processor and executed. Decoders commonly are packaged in consumer electronics devices, such as smartphones, tablet computers, gaming systems, DVD players, portable media players and the like; and they also can be packaged in consumer software applications such as video games, media players, media editors, and the like. And, of course, these components may be provided as hybrid systems that distribute functionality across dedicated hardware components and programmed general-purpose processors, as desired.

Video coders and decoders may exchange video through channels in a variety of ways. They may communicate with each other via communication and/or computer networks as illustrated in FIG. 1. In still other applications, video coders may output video data to storage devices, such as electrical, magnetic and/or optical storage media, which may be provided to decoders sometime later. In such applications, the decoders may retrieve the coded video data from the storage devices and decode it.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method of coding video data, comprising:
developing a plurality of coding hypotheses each having a motion vector identifying a source of prediction for a current pixel block,
predicting a motion vector for a first one of the coding hypotheses from the motion vector of a second coding hypothesis,
determining a difference between the developed motion vector for the first coding hypothesis and the predicted motion vector for the first coding hypothesis, and
outputting, with coded data of the current pixel block, data representing the difference between the developed motion vector for the first coding hypothesis and the predicted motion vector for the first coding hypothesis.

2. The method of claim 1, wherein the predicted motion vector is determined by:
a magnitude of the second coding hypothesis,
a temporal difference between a reference frame referenced by the first coding hypothesis and a frame to which the current pixel block belongs, and
a temporal difference between a reference frame referenced by the second coding hypothesis and the frame to which the current pixel block belongs.

3. The method of claim 1, further comprising outputting a representation of the motion vector of the second coding hypothesis.

4. The method of claim 1, further comprising:
predicting the motion vector of a second coding hypothesis,
determining a difference between the developed motion vector for the second coding hypothesis and the predicted motion vector for the second coding hypothesis, and
outputting, with coded data of the current pixel block, data representing the difference between the developed motion vector for the second coding hypothesis and the predicted motion vector for the second coding hypothesis.

5. The method of claim 4, further comprising:
predicting a motion vector prediction residual from the determined difference between the developed motion vector for the second coding hypothesis and the predicted motion vector for the second coding hypothesis,
wherein the determined difference for the first coding hypothesis represents a difference between the developed motion vector supplemented by the predicted motion vector for the first coding hypothesis and the predicted motion vector prediction residual.

6. The method of claim 1, further comprising repeating the method for a second pair of coding hypotheses.

7. A method of coding video data, comprising:
developing a plurality of coding hypotheses each having a motion vector identifying a source of prediction for a current pixel block,
predicting a motion vector for a first one of the coding hypotheses,
determining a difference between the developed motion vector for the first coding hypothesis and the predicted motion vector for the first coding hypothesis, and
outputting, with coded data of the current pixel block, data representing the difference between the developed motion vector for the first coding hypothesis and the predicted motion vector for the first coding hypothesis.

8. The method of claim 7, further comprising outputting a syntax element indicating that the outputted difference data applies to motion vectors for the first and second coding hypotheses.

9. The method of claim 7, further comprising repeating the method for a second pair of coding hypotheses.

10. A video coding system, comprising:
a predictor that:
develops motion vectors identifying prediction references for each of a plurality of coding hypotheses,
predicts a motion vector for a first one of the coding hypotheses from the motion vector of a second coding hypothesis,
determines a difference between the developed motion vector for the first coding hypothesis and the predicted motion vector for the first coding hypothesis;
a pixel block encoder that codes a current pixel block differentially with respect to a predicted pixel block developed by the motion vectors for the first and second hypotheses; and
a syntax unit that outputs coded data of the current pixel block including data representing the difference between the developed motion vector for the first coding hypothesis and the predicted motion vector for the first coding hypothesis, and data representing the second hypothesis.

11. A method of decoding coded video data, comprising:
responsive to a motion vector prediction residual supplied in coded video data for a first coding hypothesis applied to a current pixel block, predicting a motion vector for the first coding hypothesis from motion vector data supplied in the coded video data for a second coding hypothesis applied to the current pixel block,
recovering a motion vector for the first coding hypothesis from the predicted motion vector and the motion vector prediction residual,
developing a prediction pixel block for the current pixel block for the first coding hypothesis using the recovered motion vector, and
decoding the current pixel block using the developed prediction pixel block.

12. The method of claim 11, further comprising:
developing a prediction pixel block for the current pixel block for the second coding hypothesis using the motion vector data supplied in the coded video data for the second coding hypothesis,
wherein the decoding the current pixel block uses the developed prediction pixel block for the second coding hypothesis.

13. The method of claim 11, further comprising:
predicting motion vector data for the second coding hypothesis,
recovering a motion vector for the second coding hypothesis from the predicted motion vector and the motion vector data supplied in the coded video data for the second coding hypothesis,
developing a prediction pixel block for the current pixel block for the second coding hypothesis using the recovered motion vector data for the second coding hypothesis,
wherein the decoding the current pixel block uses the developed prediction pixel block for the second coding hypothesis.

14. The method of claim 11, further comprising repeating the method for another pair of coding hypotheses.

15. A method of decoding coded video data, comprising:
predicting a motion vector for a first coding hypothesis for a current pixel block,
predicting a motion vector for a second coding hypothesis for a current pixel block,
responsive to a motion vector prediction residual supplied in coded video data:
developing a first recovered motion vector from the predicted motion vector for the first coding hypothesis and the motion vector prediction residual,
developing a second recovered motion vector from the predicted motion vector for the second coding hypothesis and the motion vector prediction residual,
predicting a motion vector for a second coding hypothesis for a current pixel block, developing a first prediction pixel block for the current pixel block using the first recovered motion vector, and
developing a second prediction pixel block for the current pixel block using the second recovered motion vector, and
decoding the current pixel block using the first and second prediction pixel blocks.

16. The method of claim 15, further comprising repeating the method for another pair of coding hypotheses.

17. A video decoding system, comprising:
a predictor that:
responsive to a motion vector prediction residual supplied in coded video data for a first coding hypothesis applied to a current pixel block, predicting a motion vector for the first coding hypothesis from motion vector data supplied in the coded video data for a second coding hypothesis applied to the current pixel block,
recovering a motion vector for the first coding hypothesis from the predicted motion vector and the motion vector prediction residual,
developing a prediction pixel block for the current pixel block for the first coding hypothesis using the recovered motion vector; and
a pixel block decoder that decodes a current pixel block differentially with respect to prediction pixel block developed by the predictor and coded pixel block data.

18. Computer readable medium storing program instructions that, when executed by a processing device, cause the processing device to perform a method of coding video data, comprising:
developing a plurality of coding hypotheses each having a motion vector identifying a source of prediction for a current pixel block,
predicting a motion vector for a first one of the coding hypotheses from the motion vector of a second coding hypothesis,
determining a difference between the developed motion vector for the first coding hypothesis and the predicted motion vector for the first coding hypothesis, and
outputting, with coded data of the current pixel block, data representing the difference between the developed motion vector for the first coding hypothesis and the predicted motion vector for the first coding hypothesis.

19. The medium of claim 18, wherein the program instructions further cause the processing device to determine the predicted motion vector by:
a magnitude of the second coding hypothesis,
a temporal difference between a reference frame referenced by the first coding hypothesis and a frame to which the current pixel block belongs, and
a temporal difference between a reference frame referenced by the second coding hypothesis and the frame to which the current pixel block belongs.

20. The medium of claim 18, wherein the program instructions further cause the processing device to output a representation of the motion vector of the second coding hypothesis.

21. The medium of claim 18, wherein the program instructions further cause the processing device to:
predict the motion vector of a second coding hypothesis,
determine a difference between the developed motion vector for the second coding hypothesis and the predicted motion vector for the second coding hypothesis, and
output, with coded data of the current pixel block, data representing the difference between the developed motion vector for the second coding hypothesis and the predicted motion vector for the second coding hypothesis.

22. The medium of claim 21, wherein the program instructions further cause the processing device to:
predict a motion vector prediction residual from the determined difference between the developed motion vector for the second coding hypothesis and the predicted motion vector for the second coding hypothesis,
wherein the determined difference for the first coding hypothesis represents a difference between the developed motion vector supplemented by the predicted motion vector for the first coding hypothesis and the predicted motion vector prediction residual.

23. Computer readable medium storing program instructions that, when executed by a processing device, cause the processing device to perform a method of coding video data, comprising:
developing a plurality of coding hypotheses each having a motion vector identifying a source of prediction for a current pixel block,
predicting a motion vector for a first one of the coding hypotheses,
determining a difference between the developed motion vector for the first coding hypothesis and the predicted motion vector for the first coding hypothesis, and
outputting, with coded data of the current pixel block, data representing the difference between the developed motion vector for the first coding hypothesis and the predicted motion vector for the first coding hypothesis.

24. The medium of claim 23, wherein the program instructions further cause the processing device to output a syntax element indicating that the outputted difference data applies to motion vectors for the first and second coding hypotheses.
